(19) United States
(12) Patent Application Publication
(10) Pub. No.: US 2025/0354824 A1
(43) Pub. Date: Nov. 20, 2025

(54) COMPUTER-IMPLEMENTED METHOD FOR VERIFYING AND APPROVING A MAP EXTENSION FOR A DIGITAL MAP FOR USE IN A MOVABLE DEVICE

(71) Applicant: Robert Bosch GmbH, Stuttgart (DE)

(72) Inventor: Jan Rohde, Dettingen Unter Teck (DE)

(21) Appl. No.: 19/197,084

(22) Filed: May 2, 2025

(30) Foreign Application Priority Data
May 17, 2024 (DE) 10 2024 204 584.5

(51) Int. Cl. G01C 21/00

(52) U.S. Cl. CPC G01C 21/3804

(57) ABSTRACT

A computer-implemented method for verifying and approving a map extension for a digital map for use in a movable device, in particular in a vehicle or a robot. The digital map includes at least one connection region. The map extension includes at least one extension region and one overlap region. The overlap region describes an at least partially identical environmental region as the connection region of the digital map.

### CROSS REFERENCE

The present application claims the benefit under 35 U.S.C. § 119 of Germany Patent Application No. DE 10 2024 204 584.5 filed on May 17, 2024, which is expressly incorporated herein by reference in its entirety.

### FIELD

The present invention relates to a computer-implemented method for verifying and approving a map extension for a digital map for use in a movable device. The present invention further comprises a computing unit, a computer program product, and a machine-readable storage medium.

### BACKGROUND INFORMATION

Computer-implemented methods for verifying and approving map extensions for digital maps for use in movable devices are described in the related art.

### SUMMARY

It is an object of the present invention to provide an improved computer-implemented method for verifying and approving map extensions for a digital map for use in a movable device.

The problem may be solved by a computer-implemented method having certain features of the present invention. Advantageous embodiments of the present invention are disclosed herein.

According to a first aspect of the present invention, a computer-implemented method is provided for verifying and approving a map extension for a digital map for use in a movable device, in particular in a vehicle or a robot. The digital map comprises at least one connection region. The map extension comprises at least one extension region and one overlap region, wherein the overlap region describes an at least partially identical environmental region as the connection region of the digital map. According to an example embodiment of the present invention, the method comprises the following steps:
verifying the map extension with the aid of the connection region and the overlap region, wherein a geometric reconciliation and/or a feature-based localization between the connection region and the overlap region is performed for the verification, wherein at least one data set and at least one associated comparison data point having at least one specified tolerance value are used for the geometric reconciliation and/or the feature-based localization, wherein a position estimation of the movable device and/or a self-movement estimation of the movable device is used as the data set for the overlap region, wherein a measured value from at least one measurement run is used as the comparison data point for the connection region, and wherein the at least one data set is compared with the comparison data point.
approving the map extension for the digital map for use in the movable device if, when verifying the map extension, the comparison between the data set and the associated comparison data point is within the range of the specified tolerance value.

As a result, a technical advantage can be achieved of providing an improved method for verifying and approving a map extension for a digital map. For this purpose, the connection region and the overlap region are subjected to a verification. For the verification, a geometric reconciliation and/or a feature-based localization are performed, wherein the data set used is compared with a corresponding comparison data point. Thus, a kind of consistency check is performed for the connection region and the overlap region. Advantageously, an improved estimation or statement regarding the quality of the map extension can be made as a result. Furthermore, it can be verified whether the map extension has been integrated into the digital map with sufficient precision. Due to this verification, it is possible to approve the map extension for the digital map and use it in the same way in the movable device. Furthermore, the advantage can be achieved that even regions of an environment that are not mapped or only insufficiently mapped can be integrated into an existing digital map efficiently and with high precision.

In a further example embodiment of the present invention, the map extension is approved for the digital map for controlling a driving function for the movable device. As a result, the technical advantage can be achieved, for example, that the map extension can also be used for map-based driver assistance systems within the movable device.

In a further example embodiment of the present invention, the map extension is approved for the digital map for partially and/or fully autonomous control of the driving function, and/or the map extension is approved for safety-relevant driving functions for controlling the movable device. As a result, the technical advantage can be achieved, for example, that the map extension can be used for map-based control, in particular for fully autonomous map-based control, of the movable device. As a result, the steps required for the map-based initialization of the driving function can already be performed at the start of the drive, for example in a private parking lot. For example, sensor calibrations can be performed at an early stage. Furthermore, the advantage can be achieved of being able to use highly autonomous driving functions for a longer distance.

In a further example embodiment of the present invention, the map extension and the digital map are reconciled with the aid of correspondence-based alignments, wherein in particular point correspondences, and/or patch correspondences, and/or line correspondences are used for the reconciliation. As a result, the technical advantage can be achieved, for example, that the reconciliation, or the merging, of the map extension and the digital map can be performed with a high degree of accuracy. Due to the use of correspondence-based alignments, the efficiency of the method can also be improved.

In a further example embodiment of the present invention, in an additional method step, the map extension is verified with the aid of redundant comparison information having specifiable tolerance values, wherein satellite images and/or measurement data of a sensor from the measurement run are used as redundant comparison information, wherein the map extension and the redundant comparison information are verified with regard to geometric deviations taking into account the specifiable tolerance values. The map extension is approved if the geometric reconciliation is within the specifiable tolerance values. As a result, the technical advantage can be achieved, for example, that the method offers additional accuracy and safety. Due to the comparison of the map extension with redundant comparison information, an additional verification of the map extension can be provided. In other words, this additional method step makes it possible to determine whether the map extension has been recorded with sufficient accuracy and completeness. In the event that there are major discrepancies when comparing with the comparison information, the map extension can be blocked or rejected for use in the movable device. Thus, the method can provide additional safety for verifying the map extension.

In a further example embodiment of the present invention, the measurement data for the comparison information is used in the form of various types of data, such as lidar data, and/or radar data, and/or video camera data, and/or infrared data, and/or magnetic field data, and/or ultrasound data, wherein a different type of measurement data than the type of measurement data on which the map extension is based is used as redundant comparison information. As a result, the technical advantage can be achieved, for example, that the method provides additional safety and increased accuracy.

In a further example embodiment of the present invention, an estimation of a position of the movable device for the overlap region is ascertained as a data set for the feature-based localization. As a comparison data point for the connection region, a localization of the movable device within the digital map during the measurement run is ascertained. As a result, the technical advantage can be achieved, for example, that the overlap region and the connection region are verified with particular accuracy. Due to the estimation of the position within the overlap region and the comparison with the actual position in the connection region, a precise statement regarding the quality and integration of the map extension can be made.

In a further example embodiment of the present invention, for the feature-based localization, a self-movement estimation of the movable device for the overlap region is ascertained as a data set, and an actual movement of the movable device during the measurement run is ascertained as a comparison data point for the connection region. As a result, the technical advantage can be achieved, for example, of obtaining improved security for the use of the map extension in the movable device. For this purpose, a self-movement estimation is ascertained for the overlap region; i.e., on the basis of the map extension, an estimation is performed of how a movable device would behave in the overlap region if, for example, it were to be controlled automatically by the driving function. The result of the estimation is then compared with one or preferably a plurality of measurement runs in the connection region of the digital map. This can also be referred to as “shadow mode.” This offers the advantage that when verifying the map extension, not only the geometric environmental data are subjected to a consistency check, but at the same time a virtual or simulated self-movement estimation can also be verified for its accuracy.

According to a second aspect of the present invention, a computing unit is provided, which is configured to carry out all steps of the method according to the first aspect of the present invention.

According to a third aspect of the present invention, a computer program is provided comprising instructions that, when the computer program is executed by a computer, cause the computer to perform a method according to the first aspect of the present invention.

According to a fourth aspect of the present invention, a machine-readable storage medium is provided on which the computer program according to the third aspect of the present invention is stored.

The present invention is explained in more detail below with reference to exemplary figures and exemplary embodiments.

### BRIEF DESCRIPTION OF THE DRAWINGS

FIG. 1 is a schematic flow chart of an example method according to a first aspect of the present invention.

FIG. 2 is a simplified exemplary representation of a digital map and a movable device.

FIG. 3 is a simplified exemplary representation of a map extension.

FIG. 4 shows an exemplary verification of the digital map and the map extension with the aid of the feature-based localization.

FIG. 5 shows a further exemplary verification of the digital map and the map extension with the aid of the redundant comparison information.

FIG. 6 shows a schematically highly simplified computing unit according to a second aspect of the present invention.

FIG. 7 is a schematically highly simplified representation of a machine-readable storage medium according to a fourth aspect of the present invention.

### DETAILED DESCRIPTION OF EXAMPLE EMBODIMENTS

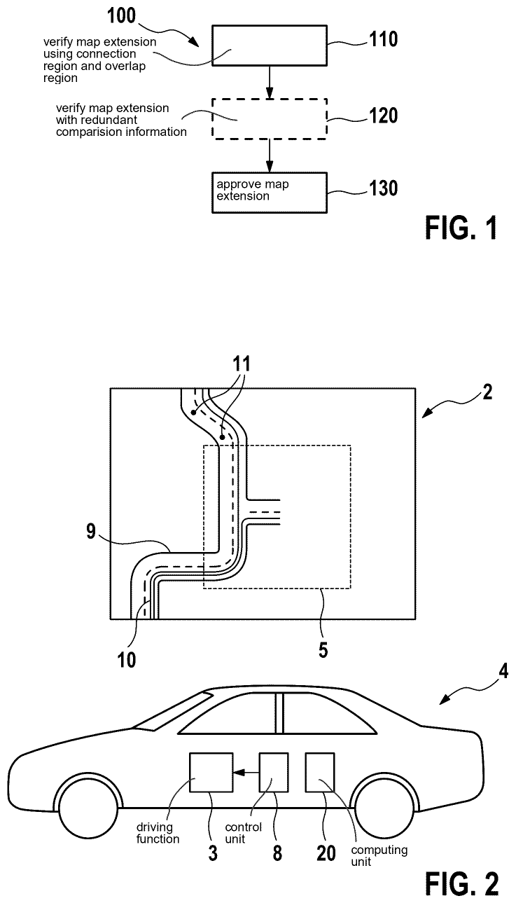

FIG. 1 is a schematic flow chart of a method 100 according to a first aspect.

The method 100 is a computer-implemented method 100 for verifying and approving a map extension for a digital map. The map extension and the digital map are for use in a movable device; in particular, the map extension for the digital map can be used in a vehicle or in a robot. The map extension processed by the method 100 comprises at least one extension region and one overlap region. The digital map comprises at least one connection region. The overlap region of the map extension and the connection region of the digital maps describe an at least partially identical environmental region.

In particular, the digital map can be a high-precision digital map. Furthermore, it is possible that the digital map is a so-called behavior map and can be used for map-based control of a driving function for a movable device. It is also possible that the map extension can be provided as an extension in the form of a high-precision digital map extension and, in particular, can also be designed as a behavior map. Furthermore, the digital map can be used, for example, in order to control a movable device in a map-based manner in a partially autonomous and/or fully autonomous driving mode.

The method 100 is used to verify the map extension for the digital map and to approve it for use in a movable device. For this purpose, the following method steps 110 and 130 are carried out. In an advantageous embodiment, the method 100 comprises an additional second method step 120.

In a first method step 110, the map extension is verified with the aid of the connection region and the overlap region. For the verification, a geometric reconciliation and/or a feature-based localization is performed between the connection region and the overlap region. For the geometric reconciliation and/or feature-based localization, at least one data set and an associated comparison data point having a specifiable tolerance value are used. A position estimation of the movable device and/or a self-movement estimation of the movable device is used as the data set for the overlap region. For the comparison data point, a measured value from at least one measurement run is used for the connection region. The at least one data set is then compared with the comparison data point.

Advantageously, the map extension and the digital map are reconciled with the aid of correspondence-based alignments. For the reconciliation on the basis of the correspondence-based alignments, point correspondences, and/or patch correspondences, and/or line correspondences are used in particular.

For the feature-based localization, an estimation of a position of the movable device for the overlap region can be ascertained as a data set. As a comparison value for the connection region, a localization of the movable device within the digital map during at least one measurement run can then be ascertained.

Furthermore, it is possible that for the feature-based localization, a self-movement estimation of the movable device for the overlap region can be ascertained as a data set. An actual movement of the movable device during at least one measurement run is ascertained as a comparison value for the connection region.

Particularly preferably, for the feature-based localization, both the self-movement estimation of the movable device and the estimation of the position of the movable device for the overlap region are ascertained and compared with the actual movement and the localization of the movable device.

In an additional optional method step 120, the map extension is verified with the aid of redundant comparison information.

Satellite images and/or measurement data from a sensor from at least one measurement run are used as redundant comparison information. The map extension and the redundant comparison information are verified with regard to geometric deviations.

Advantageously, the measurement data are used in the form of various types of data, such as lidar data, and/or radar data, and/or video camera data, and/or infrared data, and/or magnetic field data, and/or ultrasound data. As redundant comparison information, preferably a different type of measurement data is used than the type of measurement data on which the map extension is based.

In other words, it can be said that when verifying the map extension with redundant comparison information in the form of measurement data from a sensor, for example, lidar data are used as comparison information if the map extension was created on the basis of video camera data. As a further example, in the event that the map extension is based on video camera data, it would be possible that magnetic field or ultrasound data are used as redundant comparison information.

In a third step 130, the map extension for the digital map is approved for use in the movable device if, when verifying the map extension, the comparison between the data set and the associated comparison data is within the range of the specifiable tolerance.

In the event that the optional second method step 120 is used in the method 100, the map extension is approved if the verification in the first method step 110 and in the second method step 120 has been successfully performed.

The map extension can be approved for the digital map for controlling a driving function for the movable device. Furthermore, the map extension for the digital map can also be approved for partially and/or fully autonomous control of the driving function, and/or the map extension can also be approved for safety-relevant driving functions for controlling the movable device.

Thus, the method 100 is an efficient method for verifying and approving the map extension for the digital map. In particular, the method 100 can be used to verify a high-precision digital map and a high-precision map extension. Due to the verification of the map extension and in particular also due to the advantageous embodiments of the method, the method 100 can thus provide a highly accurate and precise method with which the map extension for the digital map can be provided for use in the movable device.

The following FIGS. 2 to 5 schematically show what such a digital map and a map extension can look like, how they can be used, and how they can be verified and approved with the aid of the method 100.

FIG. 2 is a simplified exemplary representation of a digital map 2 and a movable device 4.

The digital map 2 is for use in the movable device 4. The movable device 4 may, for example, be a vehicle. In particular, the digital map 2 can be used in the movable device 4 for controlling a driving function 3. The digital map 2 can be used in particular for controlling a driving function 3 in a partially and/or fully autonomous driving mode.

For use in the movable device 4, the digital map 2 is, for example, a high-resolution digital map 2; in particular, the digital map 2 is a behavior map for map-based control of the driving function 3. In this exemplary embodiment, the digital map 2 comprises different information about an environment and/or a driving behavior of manually controlled devices. The digital map 2 shows, by way of example, a roadway path 9. The roadway path 9 can comprise various types of road markings. For example, parking markings, boundary strip markings, or median strip markings can be stored in the digital map 2 for the roadway path 9. Furthermore, various behavior data 11 are stored in the digital map for use in the movable device 4. In addition, the digital map has trajectories 10, for example. Behavior data 11 can include, for example, average speeds and/or stopping points of manually controlled movable devices. The trajectories 10 and the behavior data 11 can be based on so-called fleet data. The fleet data are usually anonymized and come from vehicles that are manually controlled. Since the fleet data are anonymized, the digital map 2 does not contain the behavior data 11 and the trajectories 10 in all regions. For example, the anonymized data are recorded 1 km after the start of the drive and end 1 km prior to the end of the drive. Thus, digital maps often do not contain enough information for private properties, parking lots or parking garages. Without the behavior data 11 and the trajectories 10, or with only a very small number of trajectories 10 and behavior data 11, it is hardly possible to control the movable device 4 in a map-based manner with the aid of the digital map 2 in a partially and/or fully autonomous driving mode.

The digital map 2 comprises a connection region 5. The connection region 5 describes the region of the digital map 2 for which only insufficient information about a roadway path 9, trajectories 10 or behavior data 11 is available. Furthermore, the connection region 5 extends at least partially into the region of the digital map 2 in which sufficient behavior data 11, trajectories 10 or roadway paths 9 are still available.

The digital map 2 can be stored either online in the movable device 4 or in a cloud. For use of the digital map 2, the movable device 4 has, for example, a control unit 8 that is configured to control the driving function 3. For this purpose, the control unit 8 receives information from the digital map 2 on how the driving function 3 can be controlled taking into account the behavior data 11 and/or the trajectories 10. The control unit 8 can thus send, for example, instructions to the driving function 3 as to when the movable device 4 is to drive straight ahead, brake, follow a curve, or change lanes. Furthermore, it is also possible that the movable device 4, or the vehicle, has a computing unit 20. The computing unit 20 can, for example, process the information from the digital map 2 and pass it on to the control unit 8. The computing unit 20 can be provided either online in the device 4 or in a cloud.

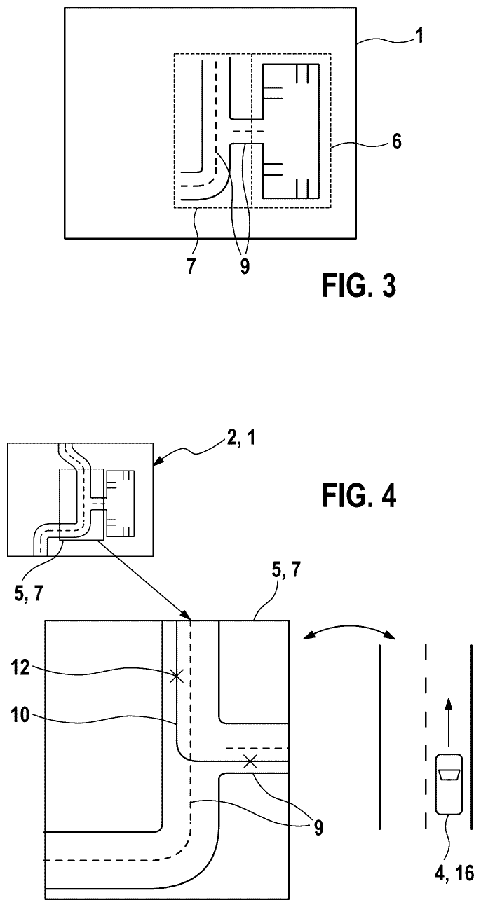

In order to be able to use such a digital map 2 also in other regions of an environment, it is therefore necessary to create a map extension and correspondingly to integrate it into the digital map 2 for use. This map extension should be created with high precision and additionally offer a high degree of safety, so that the movable device 4 can be controlled, in particular with a partially and/or fully autonomous driving function 3. An example of what such a map extension might look like is shown below in FIG. 3.

FIG. 3 is a highly simplified exemplary representation of a map extension 1.

The map extension 1 has an extension region 6 and an overlap region 7. The extension region 6 and the overlap region 7, for example, have information about a roadway path 9. The overlap region 7 corresponds at least to a partially identical environmental region as the connection region of the digital map. The extension region 6 is provided adjacent to the overlap region 7. The extension region 6 describes the region that is not present or only partially present in the digital map. The extension region 6 can, for example, be a parking lot. For mapping a private parking lot in the extension region 6, the owner of the private property must request approval for the mapping of the extension region 6. The extension region 6 and the overlap region 7 can then be recorded with the aid of sensors. Thus, different sensors of movable devices can be used for mapping or recording the map extension 1 and in particular the overlap region 7 and the extension region 6. The map extension is preferably a high-precision map extension and is created, for example, with the aid of lidar data, and/or radar data, and/or video camera data, and/or infrared data, and/or magnetic field data, and/or ultrasound data. The map extension 1 recorded with the aid of the data can then be merged with the digital map with the aid of correspondence-based alignments.

For the correspondence-based alignments, in particular point correspondences and/or patch correspondences and/or line correspondences can be used. For example, it is possible that the map extension is geometrically connected to the digital map with the aid of an FCGF method.

To ensure the correct integration of the map extension 1 into the digital map, the method described above in connection with FIG. 1 can be used. The method offers the advantage that the verification of the integration of the map extension 1 offers a high level of safety and thus the map extension 1 can also be used for partially and/or fully automated control of a movable device. The following FIGS. 4 and 5 show by way of example how such a verification of the map extension 1 for the digital map can be performed.

FIG. 4 shows an exemplary verification of the digital map 2 and the map extension 1 with the aid of the feature-based localization.

The smaller representation shows the digital map 2 with the map extension 1. Furthermore, the connection region 5 and the overlap region 7 are shown enlarged in a further detailed view. The map extension 1 and the digital map 2 may, as described above, have been connected with the aid of correspondence-based alignments on the basis of the connection region 5 and the overlap region 7. The connection region 5 and the overlap region 7 can be verified with the aid of feature-based localizations. For example, a self-movement estimation for the movable device 4 is thus estimated for the overlap region 7 of the map extension 1. The self-movement estimation can, for example, be a trajectory 10. Furthermore, a position estimation, for example in the form of localization points 12, can also be estimated for the overlap region 7 of the map extension 1. The estimated trajectory 10 is then compared with an actual movement of a movable device 4 during a measurement run 16. The actual movement is additionally provided with tolerance values. For example, an actual self-movement performed is given a tolerable deviation. Subsequently, a comparison of the actual movement performed of the movable device 4 with the estimated trajectory 10 is carried out. If the actual movement of the movable device 4 and the estimated trajectory 10 are within the specified tolerance value, or the tolerable deviation, the map extension 1 can be approved for the digital map 2. Alternatively or additionally, the position estimation can also be used for verification. In this case, an actual position of the movable device 4 within the connection region 5 is ascertained and a tolerance value is also specified for the actual position. Analogous to the process with the trajectory 10, the actual position of the movable device is then compared with the position estimation, or the localization points 12, from the map extension 1. If the comparison is within the specified tolerance value, the map extension 1 can be approved for the digital map 2.

In other words, this verification can also be referred to as “shadow mode.” “Shadow mode” because during an actual drive of the movable device 4, a previously performed estimation is compared in the background with the measurement run 16. In this way, it is verified whether, in particular, a driving function that would control the movable device 4 in an automated and/or semi-automated manner would realize the same or approximately the same behavior as a manually controlled movable device 4.

In addition, a consistency check can also be performed with the aid of redundant comparison information for the extension region 6 of the map extension 1. This is described below with the aid of FIG. 5 by way of example.

FIG. 5 shows a further exemplary verification of the digital map 2 and the map extension 1 with the aid of redundant comparison information 13.

The digital map 2 and the map extension 1 are connected to one another as in the figures described above and a parking lot, for example, is shown as the extension region 6. Advantageously, the extension region 6 is compared with redundant comparison information 13. This offers the additional advantage that, in addition to a consistency check of the overlap region and the connection region, the extension region 6 can also be verified. Satellite images 14 or measurement data 15 in the form of sensor data can be used as redundant comparison information 13, for example. The measurement data 15 can be in the form of various types of data, such as lidar data, and/or radar data, and/or video camera data, and/or infrared data, and/or magnetic field data, and/or ultrasound data. Preferably, these measurement data 15 were generated with the aid of a plurality of measurement runs 16 of measuring vehicles. On the basis of these measurement data 15, the extension region 6 is verified and compared. For this exemplary embodiment, the extension region 6 was created using lidar data, for example. The measurement data 15 for comparing the extension region 6 were recorded using video camera data, for example. Furthermore, it is also possible that the extension region 6 is reconciled with the aid of satellite images 14. For example, a large number of satellite images 14 can be recorded and compared with the extension region 6. It is also possible that both the satellite images 14 and the measurement data 15 are used as redundant comparison information 13 for verifying the extension region 6.

This additional verification with the aid of the redundant comparison information 13 allows for improved accuracy for the proposed method. If faulty information arises during the evaluation of the measurement data 15 and/or the satellite images 14 with the extension region 6, approval of the map extension 1 for the digital map 2 can be prevented.

Using the proposed method, it is thus possible to provide a map extension 1 for a digital map 2 and at the same time to provide an improved consistency check for the digital map 2 and the map extension 1. Advantageously, after the map extension 1 has been approved for the digital map 2, it can be used to control a movable device, in particular a vehicle or a robot, in a partially or fully autonomous driving mode. Due to the precise verification with the aid of the method, it can be ensured that the map extension 1 for the digital map 2 can also be approved for highly safety-relevant driving functions. The method thus makes it possible to provide a map extension 1 for a digital map 2, which can also be used in particular for private properties, parking lots, or underground garages for map-based control of a driving function.

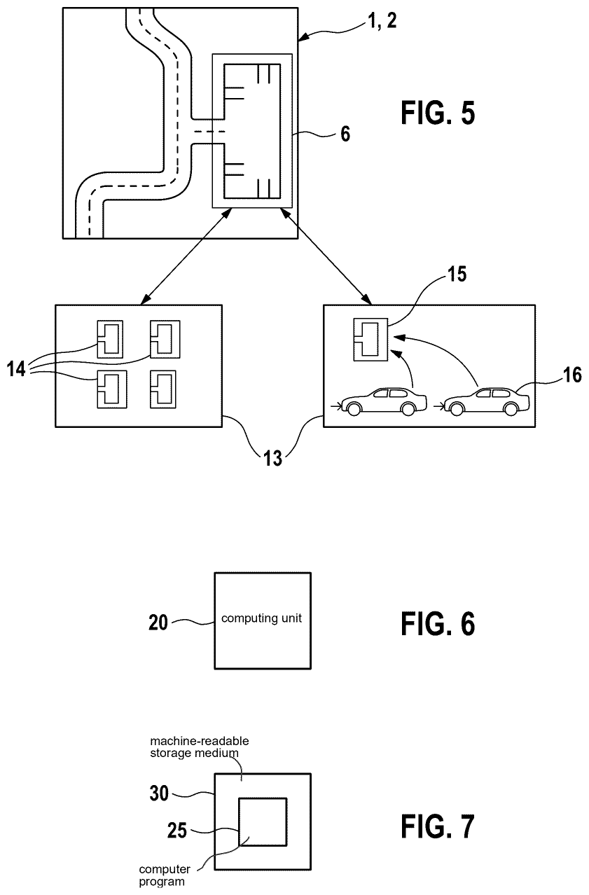

FIG. 6 shows a computing unit 20 according to a second aspect.

The computing unit 20 is configured to carry out all steps of the above-described method, also in advantageous embodiments. The computing unit 20 can in particular be a computer.

FIG. 7 shows a machine-readable storage medium 30 according to a fourth aspect.

A computer program 25 according to a third aspect is stored on the machine-readable storage medium 30. The computer program 25 comprises commands that, when the computer program 25 is executed by a computer, cause the computer to carry out a method according to the present invention. The machine-readable storage medium 30 can be read, for example, by the computing unit 20 of FIG. 6.

Although the present invention has been described herein with reference to specific exemplary embodiments, a person skilled in the art can also implement embodiments not disclosed or only partially disclosed, without departing from the essence of the present invention.

What is claimed is:

1. A computer-implemented method for verifying and approving a map extension for a digital map for use in a movable device, the movable device including a vehicle or a robot, wherein the digital map includes at least one connection region, and the map extension includes at least one extension region and at least one overlap region, wherein the overlap region describes an at least partially identical environmental region as the connection region of the digital map, wherein the method comprises the following steps:
verifying the map extension using the connection region and the overlap region, wherein a geometric reconciliation and/or a feature-based localization, between the connection region and the overlap region is performed for the verification, wherein at least one data set and at least one associated comparison data point having at least one specified tolerance value are used for the geometric reconciliation and/or the feature-based localization, wherein a position estimation of the movable device and/or a self-movement estimation of the movable device is used as the data set for the overlap region, wherein a measured value from at least one measurement run is used as the comparison data point for the connection region, and wherein the data set is compared with the comparison data point; and
approving the map extension for the digital map for use in the movable device when the data set is within the range of the specified tolerance value of the associated comparison data point.

2. The method according to claim 1, wherein the map extension is approved for the digital map for controlling a driving function for the movable device.

3. The method according to claim 2, wherein: (i) the map extension is approved for the digital map for partially and/or fully autonomous control of the driving function, and/or (ii) the map extension is approved for safety-relevant driving functions for controlling the movable device.

4. The method according to claim 1, wherein the map extension and the digital map are reconciled using correspondence-based alignments, wherein point correspondences, and/or patch correspondences, and/or line correspondences are used for the reconciliation.

5. The method according to claim 1, further comprising:
verifying the map extension using redundant comparison information having specifiable tolerance values;
wherein satellite images and/or measurement data of a sensor from the measurement run, are used as redundant comparison information;
wherein the map extension and the redundant comparison information are verified with regard to geometric deviations taking into account the specifiable tolerance values, and wherein the map extension is approved when the geometric reconciliation is within the specifiable tolerance values.

6. The method according to claim 5, wherein the measurement data are in the form of various types of data, wherein a different type of measurement data than a type of measurement data on which the map extension is based is used as redundant comparison information.

7. The method according to claim 6, wherein the different various types of data include: lidar data, and/or radar data, and/or video camera data, and/or infrared data, and/or magnetic field data, and/or ultrasound data.

8. The method according to claim 1, wherein an estimation of a position of the movable device for the overlap region is ascertained as a data set for the feature-based localization, and wherein a localization of the movable device within the digital map during the measurement run is ascertained as a comparison data point for the connection region.

9. The method according to claim 1, wherein a self-movement estimation of the movable device for the overlap region is ascertained as a data set for the feature-based localization, and wherein an actual movement of the movable device during the measurement run is ascertained as a comparison data point for the connection region.

10. A computing unit configured to verify and approve a map extension for a digital map for use in a movable device, the movable device including a vehicle or a robot, wherein the digital map includes at least one connection region, and the map extension includes at least one extension region and at least one overlap region, wherein the overlap region describes an at least partially identical environmental region as the connection region of the digital map, wherein computing unit is configured to:
verify the map extension using the connection region and the overlap region, wherein a geometric reconciliation and/or a feature-based localization, between the connection region and the overlap region is performed for the verification, wherein at least one data set and at least one associated comparison data point having at least one specified tolerance value are used for the geometric reconciliation and/or the feature-based localization, wherein a position estimation of the movable device and/or a self-movement estimation of the movable device is used as the data set for the overlap region, wherein a measured value from at least one measurement run is used as the comparison data point for the connection region, and wherein the data set is compared with the comparison data point; and
approve the map extension for the digital map for use in the movable device when the data set is within the range of the specified tolerance value of the associated comparison data point.

11. A non-transitory machine-readable storage medium on which is stored a computer program including commands verifying and approving a map extension for a digital map for use in a movable device, the movable device including a vehicle or a robot, wherein the digital map includes at least one connection region, and the map extension includes at least one extension region and at least one overlap region, wherein the overlap region describes an at least partially identical environmental region as the connection region of the digital map, the commands, when executed by a computer, causing the computer to perform the following steps:
verifying the map extension using the connection region and the overlap region, wherein a geometric reconciliation and/or a feature-based localization, between the connection region and the overlap region is performed for the verification, wherein at least one data set and at least one associated comparison data point having at least one specified tolerance value are used for the geometric reconciliation and/or the feature-based localization, wherein a position estimation of the movable device and/or a self-movement estimation of the movable device is used as the data set for the overlap region, wherein a measured value from at least one measurement run is used as the comparison data point for the connection region, and wherein the data set is compared with the comparison data point; and
approving the map extension for the digital map for use in the movable device when the data set is within the range of the specified tolerance value of the associated comparison data point.
